(19) United States
(12) Patent Application Publication
(10) Pub. No.: US 2014/0178052 A1
(43) Pub. Date: Jun. 26, 2014

(54) SYSTEMS AND METHODS FOR REMOTELY RECORDING MEDIA CONTENT

(71) Applicant: SLING MEDIA INC., Foster City, CA (US)

(72) Inventor: James Chihoon Kim, Redwood City, CA (US)

(73) Assignee: SLING MEDIA INC., Foster City, CA (US)

(21) Appl. No.: 13/726,714

(22) Filed: Dec. 26, 2012

(51) Int. Cl. H04N 9/79

(52) U.S. Cl. CPC H04N 9/79
USPC 386/297

(57) ABSTRACT

According to various exemplary embodiments, systems and methods are described for receiving a selectable icon on a webpage regarding media content to be broadcast over a broadcasting network, selecting the selectable icon, and remotely controlling a personal or digital video recorder (PVR/DVR), a set top box (STB), a placeshifting device or system that communicates with a PVR/DVR or the like, and/or another media server so as to set a timer for the recording of the advertised media content.

### TECHNICAL FIELD

The present disclosure generally relates to systems and methods for remotely recording media content, for example via a server and/or other device over a network. Such systems and techniques may be useful, for example, in remotely controlling set-top boxes, digital video recorders (DVRs), placeshifting devices and/or other types of media devices.

### BACKGROUND

The Internet and other digital communications networks continue to have significant effects on every aspect of personal and professional life. Network communications are becoming increasingly ubiquitous due to the reduced cost and increased capability of portable computing devices, as well as the increasing prevalence and capability of mobile telephony and other wireless communications technologies. Additionally, more and more devices, including set top boxes (STBs), television receivers, personal or digital video recorders (DVRs), placeshifting devices and the like are becoming enabled for communications over digital networks. Consumers are therefore expecting convenient control of their media content from a wide range of locations and settings.

Content providers are increasingly trying to determine additional ways to provide content to users. Often times, a user may not be located where the recording device associated with their television is located. At other times users may not be informed as to new offerings for programming that are available. As an example, it is now generally appreciated that many users spend a significant amount of time on social networking websites and other websites that may display selectable icons, such as advertisements or a “widget” embedded in a news article or blog posting, regarding media content that will be broadcast at a future date. If the user is not immediately in the vicinity of the user's recording device or television, the user may miss the opportunity to act on the advertisement, news article, or blog post. Therefore, opportunities for recording content of interest may be missed.

As a result, it is now desirable to create systems and methods for informing users of offerings for programming available from locations apart from the location of the user's recording device or television and for controlling such recording device, for example a DVR, STB, placeshifting device or other network-enabled media server device from such location. Such systems and methods would ideally provide a rich set of media information delivery and media control options that would be available from a wide array of client devices. These and other desirable features and characteristics will become apparent from the subsequent detailed description and the appended claims, taken in conjunction with the accompanying drawings and this background section.

### BRIEF SUMMARY

According to various exemplary embodiments, systems and methods are described for receiving a selectable icon on a webpage regarding media content to be broadcast over a broadcasting network, selecting the selectable icon, and remotely controlling a personal or digital video recorder (PVR/DVR), a set top box (STB), a placeshifting device or system that communicates with a PVR/DVR or the like, and/or another media server so as to set a timer for the recording of the advertised media content. In some embodiments, a method executable by a host communicating via a network with a client and a media server configured to record media content includes receiving a first message from the client at the host via the network. The first message is generated in response to a user selecting a selectable icon regarding the media content at the client. In response to the first message, the method further includes establishing a session between the host and the media server via the network. Still further, the method includes receiving an instruction from the client at the host to control the media server and directing the media server to execute the instruction via the session.

Other embodiments relate to a system that communicates via a network with a client and a media server configured to record media content and includes a message server configured to communicate with the media server via the network using a pre-existing connection. The message server is configured to receive a first message from the client is generated in response to a user selecting a selectable icon regarding the media content at the client. The system further includes a guide server configured to receive a request for a connection to the media server from the client via the network, to direct the message server to contact the media server via the pre-existing connection in response to the request, to establish a session via the network with the media server, to receive an instruction from the client to control the media server, and, in response to the instruction received from the client, to direct the media server via the session to execute the instruction.

Still other embodiments related to a method executable by a host communicating via a network with a client and with a media recorder having stored media content that includes receiving a first message from the client at the host via the network. The first message identifies the media recorder. The first message is generated in response to a user selecting a selectable icon regarding the media content at the client. In response to the first message, the method further includes transmitting a second message to a message server having a pre-existing connection with the identified media recorder via the network. In response to a third message received from the media recorder, the method also includes creating a session between the media recorder and the host via the network. Still further, the method includes providing program guide information from the host to the client via the network, receiving an instruction to record a program identified in the program guide information from the client at the host, and in response to receiving the instruction at the host, directing the media recorder via the session to record the identified program.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter. Various other embodiments, aspects and features are described in more detail below.

### BRIEF DESCRIPTION OF THE DRAWING FIGURES

Exemplary embodiments will hereinafter be described in conjunction with the following drawing figures, wherein like numerals denote like elements, and:

FIG. 1 is a diagram showing an Internet environment implemented according to an exemplary embodiment;

FIG. 2 is a block diagram of an advertising system according to an exemplary embodiment;

FIG. 3 is a diagram schematically showing a Web page displayed according to an exemplary embodiment;

FIG. 4 is a block diagram of an exemplary guide server host system;

FIG. 5. is a diagram showing an exemplary processes for controlling a remote media server;

FIG. 6 shows one example of an interface with guide data and a media player that could be presented by a client in some embodiments;

FIG. 7 shows one example of an interface that could be used to remotely manage programs stored on a DVR or other media server in some embodiments; and

FIG. 8 shows one example of an interface window that could be used to resolve program recording conflicts in some embodiments.

### DETAILED DESCRIPTION

The following detailed description of the invention is merely exemplary in nature and is not intended to limit the invention or the application and uses of the invention. Furthermore, there is no intention to be bound by any theory presented in the preceding background or the following detailed description.

It is generally appreciated that many people today spend a significant amount of time on social networking websites and other internet websites that display advertising content. In an exemplary embodiment, a selectable icon regarding broadcast media content, such as a television program, series, or event is displayed on a website. The selectable icon can include electronic advertisements displayed on a webpage, or a “widget” embedded in a news article or blog posting. In general, the term selectable icon refers to any graphical object that can be selected by a user on a computer, smartphone, tablet, or other such device. The selectable icon is displayed in the manner of a graphical user interface that allows the user to select the selectable icon. Upon selection of the selectable icon, the user is linked to a secondary website, such as may be operated by a third party entity or a third party mobile platform application (“app”), which allows the user to access a server that is communicatively coupled with the user's media recording system, such as a DVR, and initiate a timer for the recording of the advertised media content.

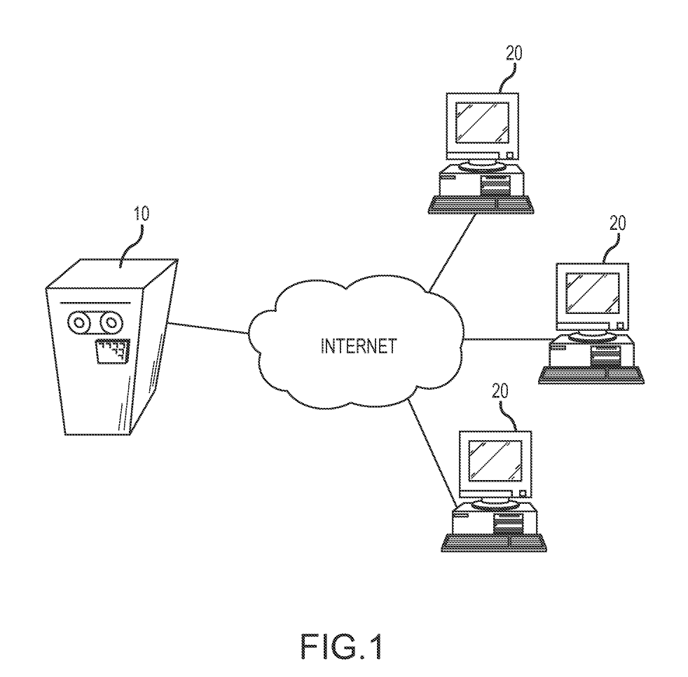

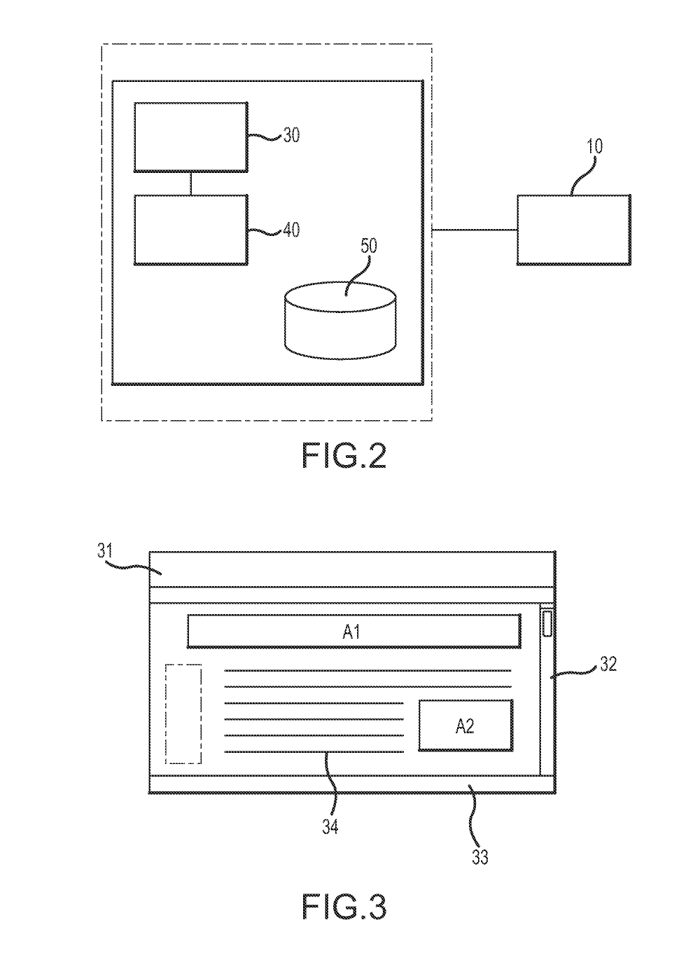

FIGS. 1-3 illustrate an exemplary webpage selectable icon system as may be provided in certain embodiments of the present disclosure. As shown in FIGS. 1-3, the system is installed in a client terminal(s) 20 provided with various types of content so that the advertising system is connected to a Web server 10 through the Internet. The term “content” as used herein includes news articles, advertisements, blog posts, and the like. The content may relate to an upcoming broadcast media program. The content can include one or more selectable icons embedded therein or associated therewith. After normally receiving information data from the Web server 10, the system provides required advertising content to a client before a corresponding Web page is displayed via a Web browser installed in the terminal instead of displaying uniform content received from the Web server 10. Conventional web browsers available for a number of different computing platforms include the INTERNET EXPLORER, MOZILLA FIREFOX, SAFARI, CHROME, and OPERA browsers, as well as many others. Such browsers are typically capable of displaying active or other documents formatted in accordance with published protocols (e.g., hypertext markup language (HTML), extensible markup language (XML), and/or the like). Many browsers 103 are also capable of executing “plugin” applications, applets or the like. Such plugins may be formatted in accordance with ActiveX, JAVA and/or any number of other formats. As noted above, the particular content displayed may, in an embodiment, be related to a particular media content that is to be broadcast at a later time over a media broadcasting network, such as a satellite, cable, internet, or over-the-art broadcast network.

For this operation, in the Internet advertising system including the terminal connected to the Web server 10 through the Internet to relay the Internet communication of clients, the system of the present invention includes a location search module 30 for searching a Web page to be displayed on the terminal 20 for the location into which new content is to be inserted in the form of a selectable icon, an identification module 40 for identifying the size and coordinates of a corresponding location found by the location search module 30, and a content database 50 for storing new content.

In order to search for a space in which the new content stored in the advertising content database 50 is to be placed, the location search module 30 reads a data source transmitted from the Web server 10 to determine the location into which the new content is to be inserted when the Web browser in the form of a selectable icon operates the data source and creates a Web page to be displayed on the terminal 20 based on the definition of HTML. Generally, as the space into which new content can be inserted, a text region occupying a certain part of a Web page, a content region, a Graphical User Interface (GUI) region of the Web browser, an empty region, etc. can be used.

The identification module 40 identifies the size and coordinates of the space found by the location search module 30. The data source received from the Web server 10 includes information about the coordinates of locations at which the content in the form of the selectable icon, text, etc. is to be aligned, sizes indicating the areas of the content and text occupying a corresponding Web page, etc. On the basis of the data source, the Web browser of the terminal 20 completes the Web page to be displayed. The identification module 120 can read the source code, and operate the size and coordinates of the empty region, the size and coordinates of the content region, the size and coordinates of the GUI region, etc.

Referring to an Internet screen displayed on a terminal 20 through a Web browser, a menu bar & tool bar 31 and an address window are sequentially arranged on the upper portion of the screen. A scroll bar 32 is placed on a right or left side of the screen to allow the Internet user to view an entire Web page while moving the scroll bar 32 upward or downward if the entire Web page cannot be displayed on a single screen. Meanwhile, a lower menu bar 33 is placed on the lower portion of the screen to provide basic information about the current Web page. A center portion surrounded by the menu bar & tool bar 31, the address window, the scroll bar 32 and the lower menu bar 33 is provided with a space in which the main content of the Web page is displayed. The space may include first and second selectable icon parts A1 and A2, in which advertising content is to be placed, and an empty region, as well as a text part 34 in which target content intended by the corresponding Web page is placed.

The content may be enabled, in connection with the GUI, with HTML or other coding to allow the user to select the selectable icon by, for example, clicking on the selectable icon with a mouse or other known means. The user may select the selectable icon, for example, if the user is interested in learning more about the media content advertised or if the user is interested in recording the media content advertised for viewing at a later date. As such, in an embodiment, the selectable icon, in addition to displaying information regarding the media content to be broadcast, may include an indication that clicking on the selectable icon may allow the user to obtain more information about the media content to be broadcast or may allow the user to record the media content on their DVR or other media content storage device.

In accordance with an embodiment, the act of selecting the selectable icon on the webpage, for example by clicking on it, results in the user being transferred to a secondary webpage that is associated with a guide server or other host that is able to establish a real-time session with a set top box (STB), television receiver, personal or digital video recorder (DVR), placeshifting device, file server or other media server that allows for direct and convenient control of the device using web or other network-based features. The guide server or other host may be operated by a third-party entity, i.e., an entity apart from either the media content production entity or the media content broadcasting entity. The networked host may be used in some embodiments to set preferences, to choose programs to be recorded by the server, to manage programs previously stored, and/or any other functions as appropriate. For example, in some embodiments the host is able to retrieve real-time (or near real-time) information about media content stored on the media server, thereby allowing for convenient search and management of the stored files, as well as the ability to direct new recordings of future programming, and/or to take other actions as desired. The host may also provide searching or other features; in some embodiments, searching may consider programming stored on the media server as well as program guide information, information about on-demand content and/or any other available information to create a very powerful search experience.

Various embodiments are able to establish real-time connections with the remote media device through the use of a messaging server that maintains a pre-existing connection with the media server. When a user wants to open a control or other session with the remote media server, the pre-existing connection can be used to establish a relatively immediate session with the online host, thereby allowing commands and other messages to be “pushed” to the media server in real-time (or near real time) rather than waiting for the media server to “pull” the information from the host.

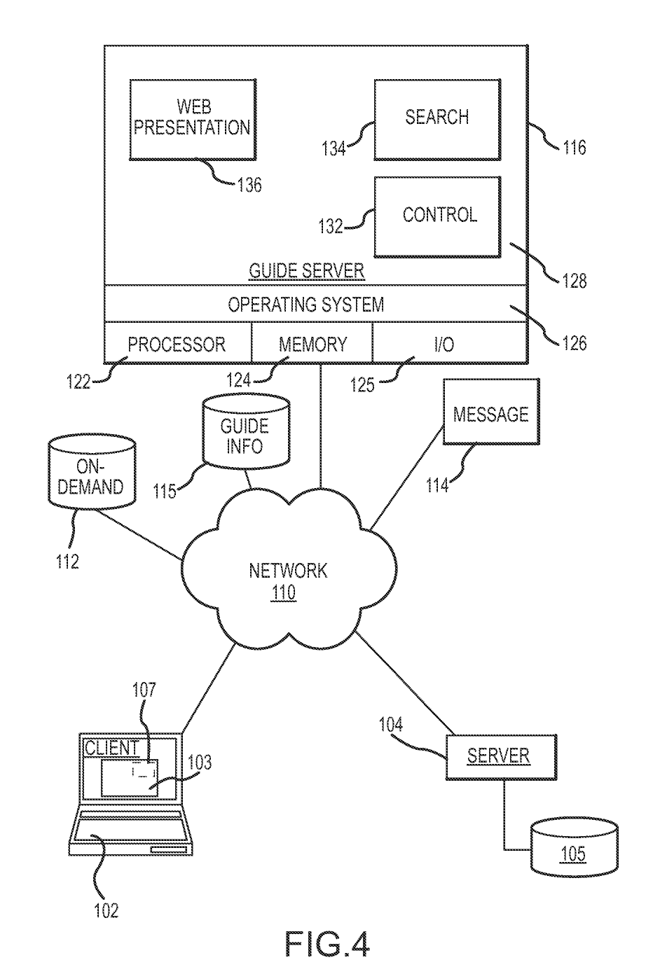

Turning now to the drawing figures and with initial reference to FIG. 4, an exemplary system 100 for remotely controlling a media server 104 suitably includes a client 102 that gains to access a guide server or other host 116 via a network 110. The client 102 may interact with the guide server host 116 using a conventional web browser 103 in some embodiments. Upon receiving a request from a client 102, which in one embodiment is the user selecting (clicking on) a selectable icon on a webpage, host 116 is able to establish a session with the media server 104 to obtain information about programming or other media content 105 available to the server 104. In an embodiment, the obtained information relates to the media programming that was advertised to the user in the selectable icon. This information may be appropriately processed and/or formatted (e.g., as a web page or the like) and provided to client 102 via network no. Other information (e.g., program guide information 115) may also be provided to the client 102. In various embodiments, a user of client 102 provides an instruction to record an upcoming program, to delete a stored program, and/or to otherwise change the content 105 that is forwarded to host 116. Upon receipt of such an instruction from client 102, host 116 appropriately directs the server 104 to execute the instruction.

Other embodiments may provide other functions or features. Some implementations may provide robust searching of content 105, for example. Such searching may consider program guide information 115, information 112 about on-demand programming, and/or other information as desired in addition to information obtained from media server 104. Other embodiments may additionally or alternately provide the ability to change preferences or other settings on media server 104, to view media content 105 in a web browser or other window, and/or to take any other actions as may be desired. For example, in the context of a selectable icon for a series of programs the searching features may allow the user to explore episode summaries, air times, and other content related to the advertised media content.

Client device 102 is the device that the user used to view the webpage containing the selectable icon (and select the selectable icon). In this regard, client 102 may be any device, component, module, hardware, software application and/or the like that is capable of communicating over network no. To that end, many different types of clients 102 may be implemented with any sort of general or special purpose hardware, software and/or firmware. In some embodiments, client 102 may be a conventional personal computer, portable computer, workstation and/or other computing system. In still other embodiments, some types of clients 102 may include personal digital assistants, video game players, mobile telephones, network appliances, network-enabled remote controls and/or any other devices capable of communicating on network no.

In the embodiment shown in FIG. 4, client 102 executes any sort of conventional browser application 103 that is compatible with standard Internet, world wide web (WWW) and/or other formats. Conventional web browsers available for a number of different computing platforms include the INTERNET EXPLORER, MOZILLA FIREFOX, SAFARI, CHROME, and OPERA browsers, as well as many others. Such browsers 103 are typically capable of displaying active or other documents formatted in accordance with published protocols (e.g., hypertext markup language (HTML), extensible markup language (XML), and/or the like). Many browsers 103 are also capable of executing “plugin” applications, applets or the like. Such plugins may be formatted in accordance with ActiveX, JAVA and/or any number of other formats.

In some embodiments, client 102 includes a media application 107. This application 107 may be a standalone media player that executes separately from browser 103 so that browser 103 may not be needed. In other embodiments, the media application 107 could be implemented as a plugin or other applet that runs within browser 103 as desired. In some embodiments, media application 107 is initially obtained from a networked host, such as host 116. The application may be retrieved on an as-needed basis in some embodiments, or may be stored at client 102 for subsequent execution. Some embodiments may not provide media viewing on client 102; such clients 102 may nevertheless be able to interact with host 116 to select programs to record, to change preferences, to control the operations of media server 104, and/or to take other actions related to media server 104.

Network no is any digital or other communications network capable of transmitting messages between senders (e.g., media server 104) and receivers (e.g., media server 104). In various embodiments, network no includes any number of public or private data connections, links or networks supporting any number of communications protocols. Network 110 may include the Internet, for example, or any other network. Such networks may be based upon TCP/IP or other conventional protocols, although other embodiments may use any type of alternate or successor protocols, as desired. In various embodiments, network no may also incorporate a wireless and/or wired telephone network, such as a cellular communications network for communicating with mobile phones, personal digital assistants, and/or the like. Various embodiments of network no may also incorporate any sort of wireless or wired local area networks, such as one or more IEEE 802.3 and/or IEEE 802.11 networks.

Media server 104 is any device or system communicating on network 110 that is capable of receiving, recording, placeshifting and/or otherwise processing media content 105. In various embodiments, media server 104 includes a personal or digital video recorder (DVR) feature that allows the server 104 to record received programming for later viewing. A DVR may a standalone device, or may be integrated within any sort of receiver (e.g., a cable, direct broadcast satellite (DBS) or other set top box (STB)) that is capable of receiving and demodulating programming signals. Other embodiments of media server 104 may include any sort of standalone or hybrid media players, file servers and/or the like that are capable of receiving, storing or otherwise processing streaming or file-based content 105 of any sort. Still other embodiments of media server 104 could implement a networked gaming server or other media service as desired.

Content 105, for example the advertised content that the user desires to record by selecting the selectable icon on the initially displayed webpage, is any sort of file-based programming or other content that is accessible to media server 104. In various embodiments, content 105 represents stored programming that is received from an internal or external television receiver. Content 105 may also represent programming received from a camera, network server and/or other source, as desired. Content may be stored in any media, including in memory, on a hard disk, on a networked server, and/or in any other digital, optical or other available storage medium. Content 105 may be stored in any sort of compressed or uncompressed format, as desired, and may be encoded or transcoded as desired for effective receipt, storage, retrieval and playing.

Some embodiments of system 100 may simply use host 116 to provide control of media server 104 for recording programs, to deleting stored content 105, changing settings or parameters, and/or performing any other desired tasks. Other embodiments, however, may allow for streaming or other playing of media content 105 from server 104 to client 102. To that end, various embodiments of media server 104 may incorporate placeshifting functionality to support viewing of content 105 over network 110 (e.g., by client 102). In some embodiments, media server 104 includes a separate placeshifting device that works in conjunction with a STB, receiver, DVR, media player or other device to shift the viewing experience from a home television to a viewing display that is accessed via network 110. Examples of placeshifting devices that may be used in some embodiments of media server 104 could include any of the various SLINGBOX products available from Sling Media of Foster City, Calif., although other products or servers 104 could be used in other embodiments. Many different types of placeshifting devices are generally capable of receiving media content from an external source, such as any sort of DVR or STB, cable or satellite programming source, DVD player, and/or the like. In other embodiments, placeshifting features are incorporated within the same device that provides content-receiving or other capabilities. Server 104 may be a hybrid DVR and/or receiver, for example, that also provides transcoding and placeshifting features. Examples of conventional placeshifting functions, features, systems and structures are described in U.S. Pat. No. 7,877,776, although the features described herein could be equivalently applied with any number of other techniques and structures in addition to those described in that particular publication.

Host 116 is any server or other network host capable of interacting with one or more clients 102 to provide instructions to one or more servers 104. In various embodiments, host 116 is a program guide server that also allows integration of program guide information 115 and/or information about available on-demand programming 112 or the like with information about content 105, as described more fully below.

FIG. 4 shows one example of a host 116 that could be used to provide a guide server that interacts with any number of clients 102 and servers 104. To that end, each host 116 within system 100 may be implemented with a server computer system or service that is based upon any processor, architecture and/or operating system. Each host 116 will typically by implemented using any sort of conventional processing hardware 122, memory 124 and input/output features 125. Various embodiments may be implemented using dedicated or shared hardware servers; other implementations may make use of virtual server features as part of a “cloud computing” service, such as any of the cloud computing services provided by AMAZON, GOOGLE, MICROSOFT, IBM, UBUNTU, SUN MICROSYSTEMS and/or any number of other providers.

Although FIG. 4 shows a single host 116 for convenience, many practical embodiments may provide a cluster or other collection of multiple hosts 116 to support any desired number of simultaneous connections. This cluster may also incorporate appropriate routing, load balancing, access and security mechanisms and or any number of other features. In various embodiments, each host 116 is an actual or virtual computer system executing an operating system 126 such as any version of LINUX, UNIX, SOLARIS, NETWARE, WINDOWS, OS/X, AIX and/or the like. The various UNIX/LINUX operating systems typically provide a computing core that is capable of executing a guide server application 128, as well as any number of daemons, processes, applications or other instance modules as desired. For example, a guide server application 128 could execute as a daemon on host 116, with connections to separate clients 102 being managed as separate processes or instances that communicate with server application 128 using features provided by operating system 126.

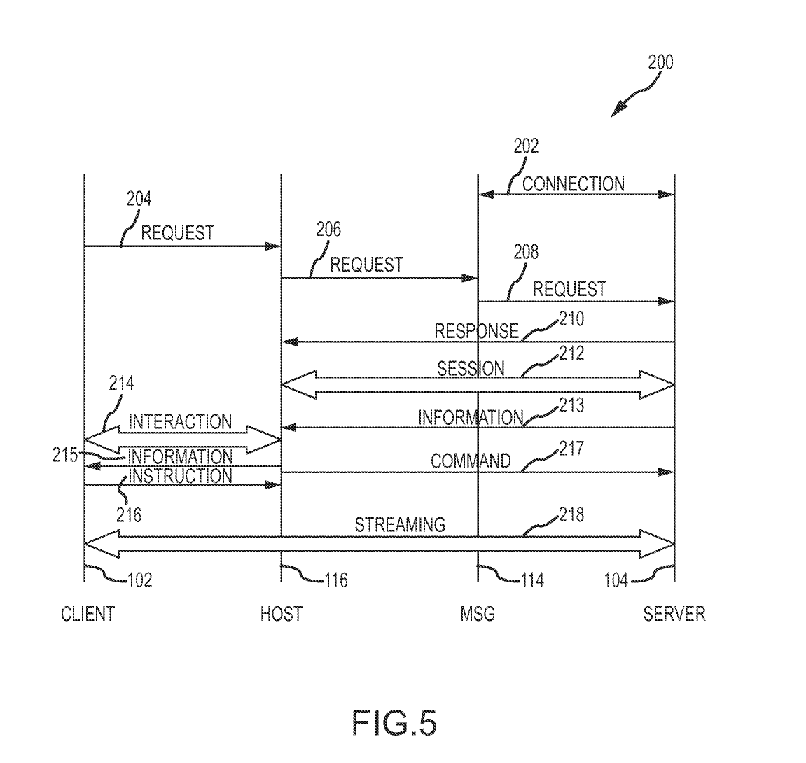

Guide server application 128 is typically initiated when host 116 is booted or otherwise initialized. In various embodiments, application 128 suitably registers with any appropriate load balancers or other routers so that connections with clients 102 can be appropriately distributed. Application 128 then processes connection requests from clients 102 as appropriate, for example as may be received as a result of a user selecting a selectable icon for a broadcast media program. In the embodiment shown in FIG. 5, guide server application 128 contains control logic 132 for controlling remotely-located servers 104 and a web server or other presentation logic 136 for providing information to client 102 in a web-based or other format that can be conveniently presented to the user. Various embodiments may also provide search engine logic 134 as desired; this search engine may perform an integrated search of information about content 105 that is stored with the remote media server 104, as well as any program guide information 115 and/or information about on-demand programming 112 as desired. Such information 112, 115 may be obtained from any database or other source available to host 116, including any database executing on a separate server or the like.

Control module 132 contains any appropriate programming logic to establish sessions over network no with one or more media servers 104 in response to requests received from clients 102. Such sessions can be used to retrieve information from the media server 104 and/or to provide instructions to the media server as desired. As described below, sessions with media servers 104 may be initiated by through one or more message servers 114 that have pre-established connections with the particular message server 114 to be contacted.

Interactions between host 116 and client 102 may be managed in any manner. In various embodiments, client 102 interacts with host 116 using a conventional web browser 107 that can receive information from a conventional web server module 136 at host 116. Such information may be provide as part of dynamic or active web content (e.g., using ASP, JAVASCRIPT, Cold Fusion, PHP and/or other content, or using JAVA, ACTIVEX and/or other plugins), and/or as static content (e.g., using HTML, XML or similar constructs). In various embodiments, presentation module 136 provides a conventional web page or similar document with embedded active content that allows the user to interact with a program guide or other information using conventional graphical user interface (GUI) constructs. The web page(s) provided from presentation module 136 may also provide a media player application 107, or may simply accommodate and interact with a media player application 107 that resides on client 102.

Guide server application 128 may provide any alternate and/or additional functions and features as desired. Generally, guide server application 128 is at least partially implemented using conventional compiled object code derived from source code in any programming language (e.g., C, C++ or the like). Other embodiments may make use of an interpreted or other abstracted environment, such as the JAVA environment available from Sun Microsystems of Sunnyvale, Calif. or the .NET environment available from Microsoft Corporation of Redmond, Wash. Other embodiments may implement the various components of guide server application 128 using any other programs, programming languages, scripting languages, development or execution environments, and/or the like. Such programming may be stored in source or object code form on any digital storage medium (e.g., memory 124, mass storage, removable media, or any other medium) that is accessible to guide server application 128.

Various embodiments therefore provide any number of message servers 114 that are each capable of maintaining pre-existing connections with one or more network server 104. Each message server 114 is implemented using conventional computer server hardware, software and/or services, such as any of the hardware or software features described above in connection with host 116.

Message server 114 suitably receives requests for connections from one or more servers 104 to initiate persistent connections with the servers 104 in any manner. In various embodiments, server 104 maintains a relatively constant connection with a messaging server 114 at a uniform resource locator (URL) or other network address that can be readily contacted on network 110. Messaging server 114 may simply be a TCP server, for example, that is automatically accessed when server 104 starts up, reboots, or otherwise initiates activity on network 110. In such cases, server 104 contacts the messaging server 114 (with the assistance of an appropriate routing or load balancing features), establishes a TCP or similar connection, and then awaits further action. This connection may be kept alive using relatively low bandwidth “keep alive” features that are part of the TCP protocol. By pre-establishing the connection from the server 104 to the messaging server 114, a pre-existing connection is maintained that can be used to send instructions or requests to the media server 104, even though the server is behind a firewall or other security mechanism. This is because many routers used in conventional firewalls will allow outgoing TCP connections that are originated within the trusted space while disallowing incoming TCP (and other) connections. After establishing a TCP or other connection from the server 104 to message server 114, that pre-existing connection can be used to transmit an instruction to server 104 to establish a separate session with the host 116. This second session can be established as another outgoing TCP (or other protocol) communication from media server 104 that is not likely to be blocked by the firewall. That is, message server 114 can transmit an instruction over the pre-existing channel that directs server 104 to separately contact host 116 and to establish an appropriate communications session between host 116 and media server 104. This instruction may optionally include information about the host 116 or other party that is requesting the connection, although this information need not be present in all embodiments. When instructed to do so, server 104 suitably establishes a TCP or other session with the host 116 that can be used to exchange data and instructions, or to perform other tasks as described more fully below.

Moreover, messages sent from message server 114 can be provided to the media server 104 on a relatively immediate basis in some embodiments. That is, if a server 116 wishes to contact a particular media server 104, the server 116 need not wait until the media server 104 polls the server 116, but rather can provide a message over network 110 in real-time, or near real-time. “Real time” in this context refers to a communication or other action that occurs in response to a stimulus (e.g., a user input, network request or the like) without substantial delay between the stimulus and the action. “Real time” communications, while typically occurring on a generally immediate basis, may nevertheless encounter and account for network and processing delays and other delays that are inherent in practical data communications systems.

System 100 therefore allows host 116 to establish a real-time session with server 104 in response to requests received from clients 102. The user of client 102 contacts host 116 by directing a browser 103 or similar program to a URL or other address associated with host 116. Upon receiving a request from client 102, host 116 suitably contacts the appropriate media server 104 via message server 114. In various embodiments, message server 114 transmits a message to the media server 104 over a pre-established connection that directs the media server 104 to contact host 116 to establish a communications session. After the communication session is established, host 116 can obtain information about programming 105 available to media server 104, and to provide any instructions to media server 104 as desired. In various embodiments, host 116 is able to interact with client 102 using web constructs or the like to provide searching of content, remote control of server 104, viewing of programming stored at server 104, and/or any other features as desired.

Turning now to FIG. 5, an exemplary process 200 for establishing a control session between a client 102 and a media server 104 using host 116 over network 110 is shown. Generally speaking, process 200 involves establishing a session 212 between host 106 and media server 104 in response to a request 204 received from a client 102. The session 212 can be used to obtain information 213 from the media server 104, to provide instructions 216 that control the operations of media server 104, and/or for any other purpose. Host 116 also interacts with client 102 as desired to provide information, to receive instructions, and/or for any other purpose. Further embodiments may also provide streaming 218 or other sharing of media content from media server 104 to client 102, as appropriate.

Typically, media server 104 initially contacts a message server 114 at startup or any other initializing state to establish a pre-existing connection 202. As noted above, media server 104 may initialize a connection 202 with a message server 114 at startup, in response to a prior connection being dropped or reset, in response to a hard or soft re-boot of the media server 104, and/or at any other appropriate time. The connection 202 then persists as the media server 104 remains connected to network 110 to allow for subsequent real-time communications. As noted above, connection 202 may be useful in circumventing a router or other security mechanism that may prevent conventional communications between host 116 and a media server 104 that may be located on a home, office, campus or other network.

Client 102 provides an initial request 204 for an interactive session in any manner. In various embodiments, a user of client 102 activates a web browser application 103, a standalone media application and/or the like and provides a known URL or other address that is associated with the host 106. The client application then formats a hypertext transport protocol (HTTP) or other query that can be transported across network 110 for receipt and processing by host 116. Other embodiments may use other protocols or formats other than HTTP or other conventional web formats. In some embodiments, request 204 (and/or other communications between client 102 and host 116) contains an identifier that can be used to authenticate the user and/or to determine a particular media server 104 to be contacted. This identifier may directly identify the media server 104 in some embodiments, although other embodiments may instead identify a user or user's account based upon userid/password combinations, digital signatures or other credentials. Media servers 104 associated with the identified user or user account may be selected, as desired, for further activity. To that end, host 116 may provide any sort of authentication of client 102 or its users in some embodiments, or any other mechanisms for selecting particular media servers 104 for further activity. Such authentication and selection may be provided using any number of messages or other interactions between host 116 and client 102, as appropriate. Host 116 may further interact with a security database, authentication server and/or any other resources to identify and authenticate the user, as desired.

Host 116 processes the received request 204 to establish a session 212 with the remotely-located media server 104. In the example process 200 shown in FIG. 5, host 116 suitably directs a message server 114 to contact the appropriate media server 104 using the pre-existing connection 202. To that end, host 116 provides a request 206 to the message server 114 or its associated load balancer, which appropriately forwards the request 206 to server 114 for further processing. Message server 114 then provides a request 208 to the media server 104 via the pre-existing connection 202 that directs the media server 104 to respond to the requesting host 116. The media server 104 appropriately responds 210 to the requesting host 116, and the media server 104 and host 116 then establish a session 212 with each other over network 110. Session 212 may be a conventional TCP session, for example, that allows for bi-directional data transfers in any convenient manner. Other embodiments may provide different types of sessions 212, including any sort of stateful or non-stateful bi-directional interchanges according to any protocols or other formats. In various embodiments, session 212 is a permanent or semi-permanent bi-directional interchange that is established in response to request 208 and that persists throughout the period of time that client 102 continues to provide instructions for control of media server 104. To that end, various embodiments may allow multiple commands, responses and/or other messages to be exchanged between host 116 and server 104 using a single, common session 212.

After session 212 is established between host 116 and the media server 104, information and commands may be exchanged in any manner. Media server 104 may provide information 213 about content 105 to host 116, for example, to allow for searching or other processing of the transferred information. In various embodiments, host 116 requests a listing of the media content 105 stored at the media server 104, as well as any metadata or other descriptive information (e.g., time of broadcast, program guide information, current preferences or other settings and/or the like) about the stored content 105 that may be available. Such information 213 may then be processed at host 116 and/or relayed to client 102, as desired.

Host 106 also interacts with client 102 to provide relevant information 215 and/or to obtain instructions 216 from the user as appropriate. To that end, information 213 may be filtered or otherwise processed at host 116 for delivery as information 215 and eventual display by client 102. In various embodiments, interaction 214 between client 102 and host 116 is implemented within the context of a conventional web session that allows active and/or passive web content to be displayed from presentation module 136 to browser 103; other embodiments may use different structures or techniques as desired.

The particular processing performed by host 106 may vary from embodiment to embodiment. In some implementations, a search engine 134 or other module is able to search and/or filter information 213 received from media server 104. Various embodiments may further obtain and process program guide information 115, information 112 about on-demand programming, and/or any other information as appropriate to provide a hybrid search feature. For example, some embodiments could allow a user to search for a particular program to obtain combined search results identifying the particular program in content 105 stored on the media server, in an upcoming broadcast, and/or in on-demand content. Hence, the flexibility and power of the search can be greatly enhanced by providing a combined search tool that accounts for different types of data, including information 213 obtained from the user's unique media server 104.

Other embodiments provide some or all of the information 213 about content 105 to client 102 to allow the client 102 to perform any desired actions. In various embodiments, client 102 provides instructions 216 to host 116 that identify desired actions to be performed by the remotely-located media server 104. Such actions may include, for example, recording a particular program, deleting a particular program, updating a setting or preference, controlling the playback of live or pre-recorded programming, and/or the like. The system may be used to automatically record programs that will occur in the future. Input information may include the channel, time, and duration of a program to be recorded. This may be referred to as the setting of a “timer” to record the media program. Various embodiments may also facilitate streaming or other viewing of content 105 stored with media server 104 on client 102. In such embodiments, host 116 suitably receives the media stream 218 from media server 104 and relays the stream 218 to client 102. Other embodiments may provide streaming in any other manner.

Instructions 216 may be received at host 116 via interaction 214 in any manner. Commands 217 are then provided from host 116 to the remote server 104 via session 212 or the like to control the operation and/or media processing functions of media server 104. Various interactions between client 102, host 116 and media server 104 that make use of commands 217 are described below with respect to interfaces 300, 400 and 500. Generally speaking, the various tasks shown in connection with process 200 may be carried out with any sort of hardware, software and/or firmware logic within system 100. In various embodiments, the various steps of process 200 are carried out in response to software or firmware instructions stored in a memory, or on a disk drive and/or other storage associated with host 116, message server 114, client 102 and/or media server 104 as shown. Such instructions may be executed by any processor and/or other processing features within host 116, message server 114, media server 104, client 102 and/or the like as indicated in FIG. 5. The particular means used to implement each of the various functions shown in FIG. 5, then, could be any sort of processing hardware executing conventional software logic in any format that implements the various algorithms and techniques described herein. Each of the messages shown in FIG. 5 may be formatted using any conventional or proprietary formats compatible with network 110, such as any sort of TCP/IP compatible formats or protocols, although other protocols could be used in other embodiments.

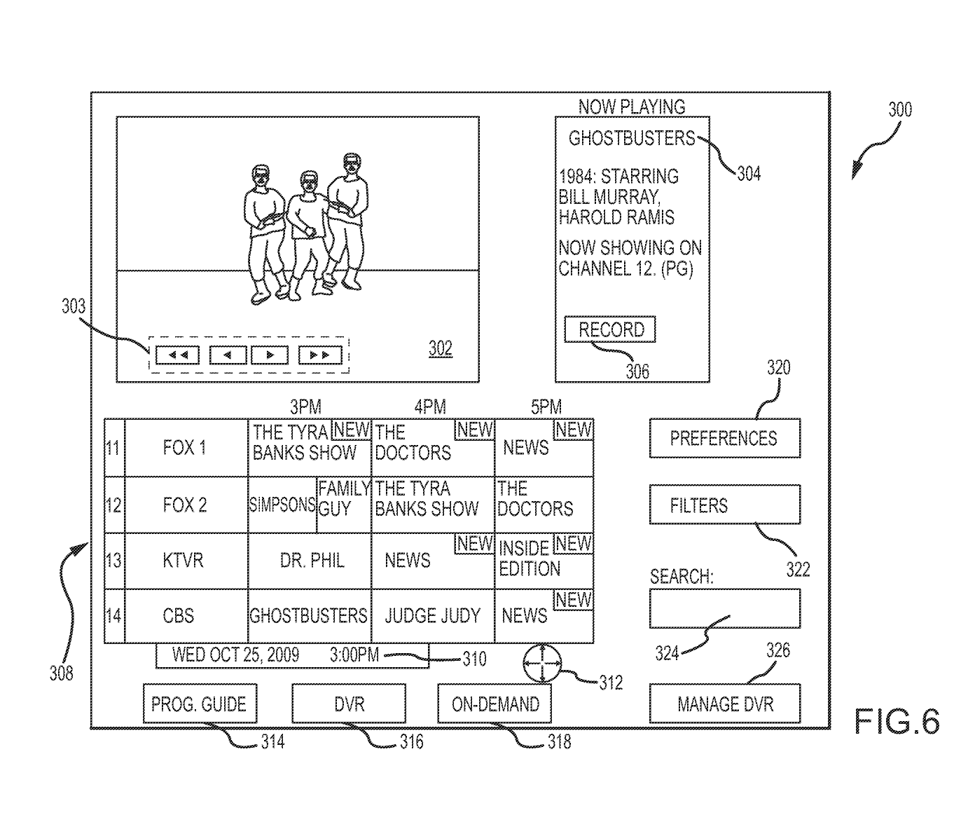

FIGS. 6-8 show exemplary interfaces 300, 400 and 500 illustrating various features that may be provided in some embodiments. The actual features implemented may vary from embodiment to embodiment, however, and the graphical or other interface elements used to implement these features may similarly vary significantly. The graphical and spatial layout of the interfaces 300, 400 and 500, then, are purely exemplary. Each of the interfaces 300, 400, 500 may be generated in any manner. In various embodiments, some or all of interfaces 300, 400 and 500 are presented by browser 103 or another application on a suitable display that is associated with client 102. Such interfaces may include active and/or static content that is provided by presentation module 135 or the like.

FIG. 6 shows an exemplary interface 300 that may be used to provide guide information 115 to client 102, and to allow interactions with remote media server 104 based upon the guide information 115. As shown in FIG. 6, the exemplary interface 300 includes a media player 302, a guide window 308, a window 304 displaying information about the currently-viewed program, and/or any other interface features as desired.

Guide window 308 provides information about programming that is available from one or more sources. Such information may be obtained via interaction 214 with host 116, and may include program guide information 115 about upcoming broadcast programs, information about content 105 stored with media server 104, information 112 about on-demand programming, and any other information as desired. In particular, in an embodiment, guide information 115 can relate to the media content shown to the user in the selectable icon on the webpage. FIG. 6, for example, shows program guide information 115 for programming that can be received by an STB or other receiver associated with media server 104. In various embodiments, the viewer can simply select a currently-broadcast program to direct the remote server 104 to tune to the particular program and provide the program in a media stream 218 to client 102. In other embodiments, clicking on or otherwise selecting a program in window 308 could result in additional information about the program being displayed (e.g., in window 304), or any other actions as desired. The exemplary embodiment shown in FIG. 6 provides a “new” label on each of the programs that are believed to be first run (as opposed to re-runs) for viewer convenience. Other embodiments may not provide this feature, however, or the label may be activated/deactivated in response to a viewer preference, as appropriate.

Although the particular view of window 308 illustrated in FIG. 6 shows program guide information corresponding to a broadcast source, other views of window 308 may show information about stored programming 105 available to media server 104, on-demand content 112 available from a website or other source, and/or other content from any other source. Guide window 308 could equivalently display search results or any other listings of available programming, as desired. The different guide views may be selected using, for example, buttons 314, 316, 318 or the like. One or more scrolling buttons, sliders or other navigation features 312 may also be provided to allow viewing of additional information as desired.

In addition to allowing the user to view information for the advertised media content, additional information presented in window 308 may be selected and/or filtered in any manner. Filtering feature 322, for example, could allow a viewer to set a content filter that would prevent certain programming from being displayed in window 308 and/or viewed by media player 302. Filtering may be useful in establishing parental controls, for example, or other filters based upon content ratings, other guide data, or the like. Filters could be applied to block any programming that meets certain criteria (e.g., adult or violent content during certain hours). Other filters may be affirmatively applied such that only programming that meets certain criteria (e.g., only children's programming during certain hours) is displayed or viewed. Such filters may be established and/or modified using any sort of convenient interface. Further, filtering 322 may not be limited to viewing of programs on client 102; to the contrary, any fillers established using client 102 may be provided to media server 104 via session 212 and applied across other displays, as desired.

In addition to information regarding the advertised media content, interface 300 could also be used to set or change any settings or other preferences 320 associated with client 102 or media server 104. Such settings may allow the viewer to select, for example, preferences for particular programming genres, sports, networks, channels, actors/actresses or other viewing choices. Such information may be used to optimize (or at least improve) search results, or for any other purpose. Preferences may be set using any interface feature 320 or the like.

As noted above, this additional, optional search feature may be provided through a search feature 324 or the like. In such embodiments, the viewer enters a keyword, title or other search term. Client 102 suitably forwards the search terms to host 116 via interaction 214, and host 116 processes the search (e.g., using search engine 134) to identify available programming that meets the search criteria. In various embodiments, host 116 is able to search for programming from multiple sources so that a complete result can be provided to client 102. For example, if the viewer searches for a particular program, host 116 may be able to identify one or more episodes of the program in stored content 105, in upcoming broadcasts (as identified by program guide information 115), in on-demand programming, and/or in any other available sources. These results can be returned from host 116 to client 102 for display in window 308 or elsewhere to allow the viewer to take any desired action. If the program is identified in a future broadcast, for example, the viewer may opt to direct the media server 104 to record the upcoming showing. If the program is available in content 105 from media server 104 and/or any other on-demand source, then the viewer may select the program for immediate viewing. These results may be inter-combined in any manner. For example, a search result could indicate that certain episodes of a program are stored on media server 104, that other episodes are available from an on-demand source for free or fee-based viewing, and/or that other episodes will be available to media server 104 in an upcoming broadcast. Other embodiments may provide different results or features, as desired. It will be appreciated that this additional, optional search feature may allow the user to search for media content that is related to the advertised content that the user may be desirous of recording.

Media player window 302 may correspond to media player 107 described above. In such embodiments, media player 107 renders and presents a media stream to the viewer based upon selected content. Content may be selected from programs listed in window 308, if such programs are currently available from media server 104 or another source. As noted above, various embodiments allow the viewer to select programs from guide window 308. The client 102 then provides an instruction 216 to host 116 via session 212 to appropriately direct media server 104 to begin streaming the selected programming or to take any other appropriate action. Media player 302 may also provide navigation controls 303 to rewind, stop, play, fast forward or otherwise modify the playback of the media stream 218. User commands received with respect to navigation controls 303 may be similarly relayed to media server 104 via host 116 and session 212, as appropriate.

Window 304, as shown in FIG. 6, presents information about the currently-selected content. The currently-selected program may correspond to content currently viewed in media player window 302, if the selected program is immediately available. Alternately, the currently-selected program could correspond to an upcoming program shown in a program guide, an on-demand program, or any other content within window 308 or elsewhere. In the example shown in FIG. 6, the currently-selected program is currently received at media server 104 and streamed to client 102 for immediate viewing. If the viewer wanted to record the program, a record button 306 is provided that would allow an instruction 216 to be sent to host 116, which in turn would direct media server 104 to record the program. Upcoming programs could be similarly recorded by simply selecting the upcoming program in a guide window 308, search result or the like, and then activating a record button 306 or other record feature within interface 300. Because such directions 217 could be provided to media server 104 in real-time across the current session 212, recording could be initiated on a relatively immediate basis in some embodiments.

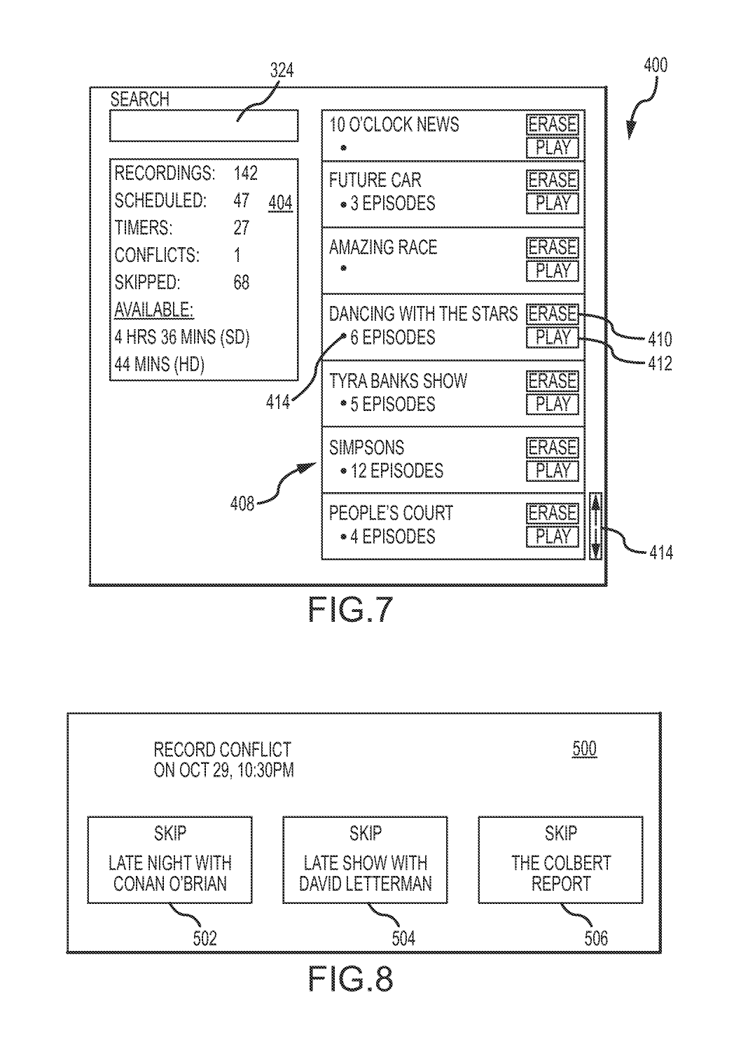

FIG. 7 shows an exemplary interface 400 that could be used in some implementations to manage the content 105 stored with media server 104. Interface 400, as illustrated in FIG. 7, includes a listing 408 of programming content 105 stored on media server 104, as well as an information window 404 that provides a current status of a disk, solid state drive and/or other data storage medium associated with media server 104. In the particular example shown in FIG. 7, programs are grouped by program title, with the number of available episodes 414 indicated as well. Other embodiments may organize and present programming listing 408 in any desired manner. A search feature 324 as described above may also be provided, as may any number of other additional or alternate features.

Interface 400 allows the viewer to manage the contents of the DVR or other repository of content 105 from client 102. Particular programs may be played from server 104, for example, by selecting a “play” feature 412 in interface 400. Selecting such a feature would result in an instruction 216 being sent to host 116, which in turn would send an appropriate message 217 via session 212 to direct the remote media server 104 to begin streaming the selected program. Messages 217 could also be generated using “erase” features 410, which would result in an instruction 216 to be provided to host 116, which in turn would direct media server 104 to erase the indicated program. Media server 104 may then provide updated information 213 in some embodiments so that listing 408 and information 404 remain accurate. Still other instructions 216 may be used, in some embodiments, to control the operation of media server 104. A mobile phone, computer or network-enabled remote control, for example, could interact with host 116 to select programming, to play, pause, record, forward/rewind or to perform other control functions as desired. Other features and functions may be provided in any number of alternate embodiments.

FIG. 8 shows an exemplary interface 500 that allows a user to select from conflicting recordings. In various embodiments, the media server 104 may be able to record only a limited number of simultaneous programs. Many conventional STBs, for example, may have tuner capabilities to receive and record two simultaneous programs, but not a third. Hence, if an instruction is received to record a third program, the viewer may be requested to select which program would not be recorded. Interface 500 shows one example of a window that could be provided that would allow the viewer to select which of program would not be recorded by activating an appropriate feature 502, 504, 506 that corresponds to the program to be skipped. Identification of recording conflicts could occur in any manner. In various embodiments, media server 104 provides a listing of currently-planned recordings as part of information 213. Such information may be provided in response to a request by host 116, or may be automatically provided as desired. In such embodiments, host 116 identifies when conflicting recordings are requested in instructions 216 from client 102, and provides interface 500 or the like in response. In other embodiments, interface 500 is generated in response to a message from media server 104 indicating that a recording conflict exists, and providing sufficient information for the viewer to resolve the conflict. Other processes and techniques may be formulated in any number of alternate embodiments.

FIGS. 4-8 therefore illustrate at least one example of a system 100 that could be used to remotely control a DVR, STB or other receiver, placeshifting device, file server or other media server 104 via a network 110. In some embodiments, the media server 104 is contacted using a persistent connection that the media server 104 previously established with a messaging server 114 to create a network session 212 with host 116; because this session allows for real-time (or near real-time) interaction between the host 116 and server 104, any number of commands 217 can be provided from host 116 to be executed on media server 104. Such commands 217 can be provided in response to user inputs at a client 102 using, for example, conventional active or static interface techniques implemented within a web browser 103 or the like. Various embodiments could use commands 217 to direct the recording, erasing, playing or other processing of programming content 105 stored at the media server 104. Other embodiments may use commands 217 to update settings or preferences, to control the operation of media server 104, and/or to take any other actions as desired.

The system 100 illustrated in FIGS. 4-8 operate in connection with the advertising system described in connection with FIGS. 1-3. In this manner, a user may select a selectable icon on a webpage pertaining to a media program using the advertising system described in FIGS. 1-3, and thereafter be seamlessly linked electronically to the system described in FIGS. 4-8 for setting a timer for recording the media program on their home (or other) device, such as a DVR.

While several exemplary embodiments have been presented in the foregoing detailed description, it should be appreciated that a vast number of alternate but equivalent variations exist, and the examples presented herein are not intended to limit the scope, applicability, or configuration of the invention in any way. To the contrary, various changes may be made in the function and arrangement of elements described without departing from the scope of the claims and their legal equivalents. The term “exemplary” is used herein to represent one example, instance or illustration that may have any number of alternates. Any implementation described herein as “exemplary” is not necessarily to be construed as preferred or advantageous over other implementations.

1. A method executable by a host communicating via a network with a client and a media server configured to record and access information regarding media content, the method comprising:
receiving a first message from the client at the host via the network, wherein the first message is generated in response to a user selecting a selectable icon regarding a first instance of media content at the client;
in response to the first message, establishing a session between the host and the media server via the network;
receiving, from the media server, information regarding the first instance of media content and a second instance of media content, wherein the second instance of media content is related to the first instance of media content;
providing the information regarding the first instance of media content and the second instance of media content to the client;
receiving an instruction from the client at the host to control the media server in a manner so as to schedule a recording of the second instance of media content at the media server; and
directing the media server to execute the instruction via the session.

2. The method of claim 1 wherein the media server comprises a digital video recorder, and wherein the instruction directs the digital video recorder to record media content that is advertised.

3. The method of claim 1 wherein the selectable icon is a graphical user interface object presented to the user on a display device of the client.

4. The method of claim 1 further comprising providing program guide information from the host to the client via the network, wherein the program guide information describes information regarding media content that is advertised.

5. The method of claim 4 wherein the media server comprises a digital video recorder, and wherein the instruction to control the media server comprises an instruction to record a program identified in the program guide information using the digital video recorder.

6. The method of claim 1 wherein the establishing comprises transmitting a request to a message server having a pre-determined connection established via the network with the media server, and wherein the pre-determined connection is established in response to a message provided by the media server.

7. The method of claim 1 wherein the session is a real-time communications session.

8. The method of claim 1 further comprising forming a web page with the selectable icon and transmitting the web page to an application executing on the client.

9. The method of claim 1 further comprising authenticating the client prior to establishing the session.

10. The method of claim 9, wherein authenticating the client comprises receiving a unique user identification/password combination from the client.

11. A system that communicates via a network with a client and a media server configured to record media content, the system comprising:
a message server configured to communicate with the media server via the network using a pre-existing connection, wherein the message server is configured to receive a first message from the client, wherein the first message is generated in response to a user selecting a selectable icon regarding a first instance of media content at the client; and
a guide server configured to receive a request for a connection to the media server from the client via the network, to direct the message server to contact the media server via the pre-existing connection in response to the request, to establish a session via the network with the media server, to receive information regarding the first instance of media content and a second instance of media content, wherein the second instance of media content is related to the first instance of media content, to provide the information regarding the first instance of media content and the second instance of media content to the client, to receive an instruction from the client to control the media server in a manner so as to schedule a recording of the second instance of media content at the media server, and, in response to the instruction received from the client, to direct the media server via the session to execute the instruction.

12. The system of claim 11 wherein the session is a real-time communications session.

13. The system of claim 11 wherein the guide server comprises a web server configured to provide the information about the media content stored at the media server in a web-compatible format.

14. The system of claim 11 further comprising a first database comprising program guide information, wherein the guide server is configured to receive the program guide information from the first database and to provide the program guide information to the client via the network, and wherein the instruction comprises an instruction to record a program identified in the program guide information that is provided to the client.

15. The system of claim 14 wherein the guide server is further configured to receive an instruction from the client to search for a particular program, to search for the particular program in both the information about the media content stored at the media server and the program guide information, and to provide a combined search result to the client.

16. The system of claim 14 wherein the media server is a placeshifting device, wherein the content stored at the media server comprises programs recorded by a user, and wherein the instruction is an instruction to record one of the programs recorded by the user that is provided in response to an input provided to the client by the user.

17. The system of claim 16 wherein the media server is further configured to authenticate the user prior to establishing the session with the media server.

18. A method executable by a host communicating via a network with a client and with a media recorder having stored media content, the method comprising:
receiving a first message from the client at the host via the network, wherein the first message identifies the media recorder, wherein the first message is generated in response to a user selecting a selectable icon regarding a first instance of media content at the client;
in response to the first message, transmitting a second message to a message server having a pre-existing connection with the identified media recorder via the network;
in response to a third message received from the media recorder, creating a session between the media recorder and the host via the network;
providing program guide information from the host to the client via the network, the program guide comprising information regarding the first instance of media content and a second instance of media content related to the first instance of media content;
receiving an instruction to record the second instance of media content from the client at the host; and
in response to receiving the instruction at the host, directing the media recorder via the session to record the second instance of media content.

19. The method of claim 18 wherein the session is a real-time communications session.

20. The method of claim 19 further comprising forming a web page with the program guide information and transmitting the web page to an application executing on the client.
